(19) United States
(12) Patent Application Publication
(10) Pub. No.: US 2025/0237250 A1
(43) Pub. Date: Jul. 24, 2025

(54) PATTERNED FRAME RAIL

(71) Applicant: United CoolAir, LLC, York, PA (US)

(72) Inventor: Christopher Alex Keller, York, PA (US)

(21) Appl. No.: 19/033,809

(22) Filed: Jan. 22, 2025

Related U.S. Application Data
(60) Provisional application No. 63/623,375, filed on Jan. 22, 2024.

(51) Int. Cl. F16B 12/50

(52) U.S. Cl. CPC F16B 12/50; F16B 2200/67

(57) ABSTRACT

The present disclosure relates to a patterned frame rail which includes an inner frame rail and a pair of outer frame rails. The inner frame rail includes a pair of mating surfaces disposed normally. Each of the mating surfaces includes oppositely disposed first and second end portions. One of the end portions is offset from the respective first and second end portions.

### CROSS-REFERENCE TO RELATED APPLICATIONS

This application claims the benefit of and priority to U.S. Provisional Patent Application No. 63/623,375 filed Jan. 22, 2024, the content of which is hereby incorporated by reference.

### FIELD OF DISCLOSURE

The present disclosure generally relates to a structural component that may be useful to facilitate attachment of external panels and connection of internal operating apparatus, and more particularly to a frame rail having a configuration that may be useful to construct a panel using four frame rails, a plurality of panels with additional frame rails and a cube with twelve frame rails to facilitate attachment of external panels and connect an internal operating apparatus thereto.

### BACKGROUND

When constructing components in a modular system, it is advantageous to use a minimum number of discrete elements for efficiency. For example, a modular HVAC system may include a modular compressor unit, a modular evaporator unit, and, optionally, a modular condenser unit, which can be collectively configured and/or re-configured to be disposed and operate in a variety of spaces, including spaces where there is limited room for traditional HVAC equipment. Configuring a modular HVAC system will require that at least the compressor unit and evaporator unit be constructed as discrete elements that are connected to one another in order to define an airflow pathway. Accordingly, there is a need for the modular units to be constructed so that the mating surfaces of the units substantially seal against one another and that an airflow pathway therebetween and therethrough may function as intended with designed efficiency, and for external panels to be connected thereto to seal other sides of the modular unit and for mounting of operational apparatus internally.

### SUMMARY

The present disclosure relates to a patterned frame rail that has a singular configuration with an inner frame rail portion and a pair of outer frame rails portions. A plurality of the patterned frame rails can be connected to one another so as to form a modular unit. Preferably, the respective mating surfaces of the inner frame rails of adjacent modular units may be disposed contiguous about their perimeters with a flush fitment such that a seal is substantially formed about and along such mating surfaces. Similarly, a side panel may be connected to the mating surfaces of the inner frame rails that define an open side of the modular unit with a flush fitment so that a seal is substantially formed about and along the side panel and mating surface engagement. The outer frame rails may be used to connect an operational apparatus thereto.

In an embodiment, the present disclosure is a frame rail comprising a first mating surface and a second mating surface joint vertex. The first and second mating surfaces each include a first end, a second end, and an intermediate portion disposed between the first end and second end. A first offset portion is oriented normal to the first mating surface. A second offset portion is oriented normal to the second mating surface. A first mounting flange is oriented normal to the first offset portion. A second mounting flange is oriented normal to the second offset portion.

In an embodiment, the first end of the first mating surface is adjacent to the second end of the second mating surface. The second end of the first mating surface is adjacent to the first end of the second mating surface. A gap separates the first end of the first mating surface from the second end of the second mating surface. A gap also separates the second end of the first mating surface from the first end of the second mating surface.

In an embodiment, the first ends of the first mating surface and second mating surface also comprise a first pair of apertures having a diameter of x oriented along a first axis and a second pair of apertures having a diameter of y oriented along a second axis.

In an embodiment, the second end of the first mating surface is offset from the vertex and the edge of the first mating surface opposite the vertex. The second end of the second mating surface is offset from the vertex and the edge of the second mating surface opposite the vertex. The second ends of the first mating surface and second mating surface further comprise a third pair of apertures having a diameter of x and oriented along the second axis.

In an embodiment, the first axis is perpendicular to the vertex and the second axis is parallel to the vertex. In an embodiment, the diameter x is less than diameter y.

In an embodiment, the frame rail also comprises a first gusset extending from the first mounting flange and a second gusset extending from the second mounting flange. In an embodiment, the first gusset forms an L-shaped bracket and comprises a first portion in parallel with and extending along a portion of the length of the first mounting flange and a second portion extending away from the first mounting flange and forming a right angle with the first portion.

In an embodiment, the second gusset forms an L-shaped bracket and comprises a first portion in parallel with and extending along a portion of the length of the second mounting flange and a second portion extending away from the second mounting flange and forming a right angle with the first portion.

In an embodiment the first gusset is connected to the first mounting flange by an offset portion that extends normal to the first mounting flange. The second gusset is connected to the second mounting flange by an offset portion that extends normal to the second mounting flange.

In an embodiment, the first portion of the first gusset extends from an outer longitudinal edge of the first mounting flange proximate the first end of the first mating surface. The first portion of the second gusset extends from an outer longitudinal edge of the second mounting flange proximate the first end of the second mating surface.

In an embodiment, each of the first and second gussets further comprise an outer edge disposed at one end of the second portion. The outer edge is oriented in parallel and planar alignment with an edge of the intermediate portion.

In an embodiment, the present disclosure is a method of assembling a corner of a frame comprising the following steps: (1) obtaining a plurality of frame rails; (2) orienting the first end of a first mounting flange of a first frame rail over a second end of a first mounting flange of a second frame rail such that the first pair of apertures are aligned in registration with the third pair of apertures; (3) orienting the first end of a second mounting flange of the second frame rail over a second end of a first mounting flange of a third frame rail such that the first pair of apertures are aligned in registration with the third pair of apertures; (4) orienting the first end of a second mounting flange of the third frame rail over a second end of a first mounting flange of the first frame rail such that the first pair of apertures are aligned in registration with the third pair of apertures; and (5) forming a corner of a frame by securing the first, second, and third frame rails by applying fasteners to the first and third pairs of apertures which are aligned in registration.

In an embodiment, the plurality of frame rails of step (1) comprise: a first mating surface and a second mating surface joined at a vertex. The first and second mating surfaces each having a first end, a second end, and an intermediate portion disposed therebetween. A first offset portion is oriented normal to the first mating surface and a second offset portion oriented normal to the second mating surface. A first mounting flange is oriented normal to the first offset portion and a second mounting flange oriented normal to the second offset portion. The first ends of the first mating surface and second mating surface further comprise a first pair of apertures having a diameter of x and oriented along a first axis, and a second pair of apertures having a diameter of y and oriented along a second axis. The second ends of the first mating surface and second mating surface further comprise a third pair of apertures having a diameter of x and oriented along the second axis.

In an embodiment, the present disclosure is a cubic frame. The cubic frame comprises a set of 12 frame rails. Each of the frame rails comprise a first mating surface and a second mating surface joined at a vertex. The first and second mating surfaces each have a first end, a second end, and an intermediate portion disposed therebetween. A first offset portion is oriented normal to the first mating surface and a second offset portion is oriented normal to the second mating surface. A first mounting flange is oriented normal to the first offset portion and a second mounting flange is oriented normal to the second offset portion. The first end of the mating surface is disposed adjacent to the second end of the second mating surface and the second end of the first mating surface is disposed adjacent to the first end of the second mating surface. A gap separates the first end of the first mating surface from the second end of the second mating surface. A gap also separates the second end of the first mating surface from the first end of the second mating surface. First ends of the first mating surface and second mating surface further comprise: a first pair of apertures having a diameter of x and oriented along a first axis, and a second pair of apertures having a diameter of y and oriented along a second axis. The second ends of the first mating surface and second mating surface further comprise a third pair of apertures having a diameter of x and are oriented along the second axis. The cubic frame further comprises a set of 48 fasteners to secure the first end of the first mating surface of each frame rail to the second end of the second mating surface of another frame rail.

At each corner of the cubic frame, the first end of the first mounting flange of a first frame rail is disposed over the second end of the first mounting flange of a second frame rail such that the first pair of apertures are aligned in registration with the third pair of apertures. In addition, the first end of the first mounting flange of the second frame rail is disposed over a the second end of the first mounting flange of a third frame rail such that the first pair of apertures are aligned in registration with the third pair of apertures. Finally, the first end of the second mounting flange of the third frame rail is disposed over the second end of the second mounting flange of the first frame rail such that the first pair of apertures are aligned in registration with the third pair of apertures.

Accordingly, it is an object of the disclosure not to encompass within the disclosure any previously known product, process of making the product, method of using the product, or method of treatment such that Applicants reserve the right and hereby disclose a disclaimer of any previously known product, process, or method. It is further noted that the disclosure does not intend to encompass within the scope of the disclosure any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product disclosed herein.

It is noted that in the present disclosure and particularly in the claims and/or paragraphs, terms such as “comprises,” “comprised,” “comprising” and the like can have the meaning attributed to them in U.S. patent law; e.g., they can mean “includes,” “included,” “including,” and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

These and other embodiments are disclosed or are obvious from and encompassed by the following Brief Description of the Drawings and Detailed Description.

### BRIEF DESCRIPTION OF THE DRAWINGS

FIG. 1 is a perspective view of an embodiment of the present disclosure directed to a patterned frame rail.

FIG. 2 is a pre-fold, flat plan view of an embodiment of the patterned frame rail of FIG. 1.

FIG. 3 is a first elevation view of the patterned frame rail of FIG. 1.

FIG. 4 is a first detail view of the patterned frame rail of FIG. 3.

FIG. 5 is a second detail view of the patterned frame rail of FIG. 3.

FIG. 6 is a second elevation view of the patterned frame rail of FIG. 1.

FIG. 7 is an end view of the patterned frame rail of FIG. 1.

FIG. 8 is a perspective view of a set of three of the patterned frame rails of FIG. 1 oriented to be connected to define a corner.

FIG. 9 is a perspective view of the three patterned frame rails of FIG. 8 connected to define a corner.

FIG. 10 is a perspective view of a set of twelve of the patterned frame rails of FIG. 1 connected to define a cube and a plurality of distinct panels therein.

FIG. 11 is a perspective view of a pair of cubes of FIG. 10 oriented to be moved into immediately adjacent disposition.

FIG. 12 is a detailed perspective view from FIG. 11 of one corner of the pair of cubes of FIG. 11.

FIG. 13 is a perspective view of an embodiment of the present disclosure directed to a patterned frame rail having a gusseted portion.

FIG. 14 is a side perspective view of the patterned frame rail of FIG. 13.

FIG. 15 is a first detail view of the patterned frame rail of FIG. 13.

FIG. 16 is a top view of the patterned frame rail of FIG. 13.

FIG. 17 is a detailed perspective view of a set of three of the patterned frame rails of FIG. 13 connected to define a corner. This FIG. 17 depicts a view of the corner from the perspective of the interior of a cube.

### DETAILED DESCRIPTION

The following detailed description, given by way of example, but not intended to limit the invention solely to the specific embodiments described, may best be understood in conjunction with the accompanying drawings.

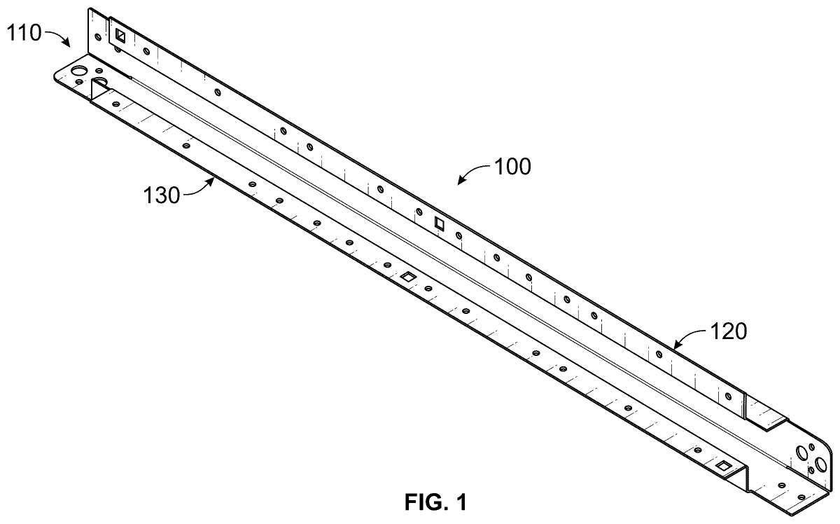

FIG. 1 is a perspective view of an embodiment of the present disclosure directed to a patterned frame rail 100 that may include an inner frame rail 110 and a pair of outer frame rails 120, 130, each disposed on opposite sides of the inner frame rail 110.

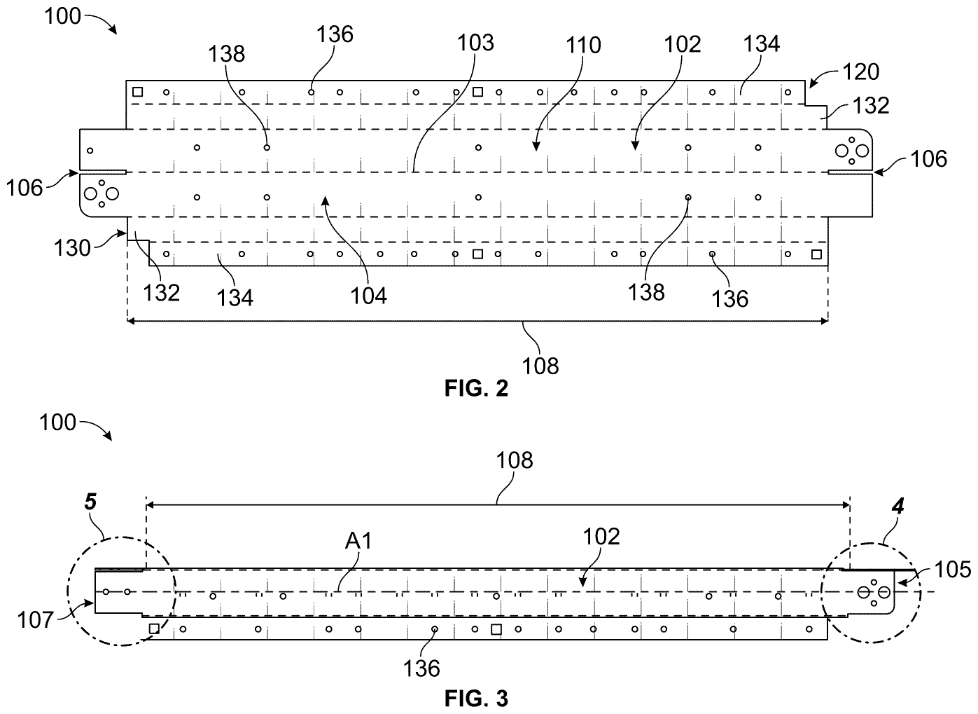

FIG. 2 is a pre-fold, flat plan view of an embodiment of the patterned frame rail 100 of FIG. 1 that may be formed from sheet metal, sheet plastic or other suitable material by bending. One of skill in the art will recognize that forming the patterned frame rail 100 of the present disclosure may also be made by extrusion or other suitable manufacturing process.

The inner frame rail 110 may include a first mating surface 102 and a second mating surface 104. Use of the term “surface” does not imply or mean that this element is only the surface as commonly understood, but rather implies and means a portion of the inner frame rail 110 that has a plurality of surfaces to define the solid body element. The first and second mating surfaces 102, 104 are disposed at least contiguous and preferably are integral. When formed the first and second mating surfaces 102, 104 are disposed normal to one another to define a L-shape (see FIG. 7 which is an end view of the frame rail 110, where a vertex 103 is defined where the first and second mating surfaces 102, 104 meet). A gap 106 is defined along the vertex 103 of the L-shape extending inward from each longitudinal end of the inner frame rail 110. An intermediate portion 108 of the first and second mating surfaces 102, 104 is defined between the longitudinally opposed gaps 106.

FIG. 3 is a first elevation view of the patterned frame rail 100 of FIG. 1. The first mating surface 102 may include a first end portion 105 and a second end portion 107. Preferably, each of the first and second end portions 105, 107 are disposed outside the intermediate portion 108 on opposite ends of the first mating surface 102.

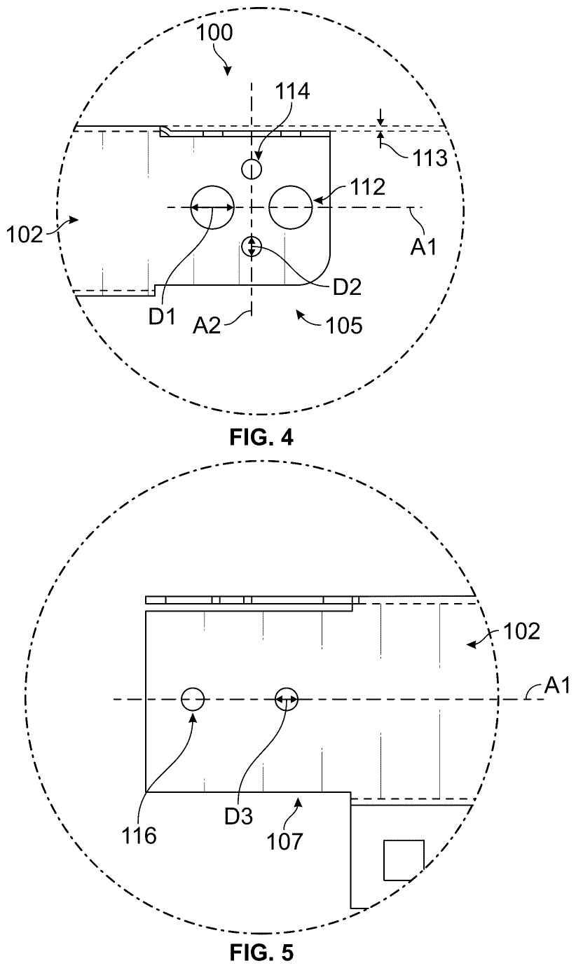

FIG. 4 is a first detail view of the patterned frame rail 100 of FIG. 3 showing the first end portion 105 of the first mating surface 102 which may include a first pair of apertures 112 that may have a first diameter D1 and the second pair of apertures 114 that may have a second diameter D2. Preferably, the first diameter D1 is larger than the second diameter D2. The first diameters D1 of the first pair of apertures 112 may be coincident with a first axis A1 and the second diameters D2 of the second pair of apertures 114 may be coincident with a second axis A2. Preferably, the first axis A1 and second axis A2 are disposed normal to one another.

FIG. 5 is a second detail view of the patterned frame rail 100 of FIG. 3 showing the second end portion 107 of the first mating surface 102 which may include a pair of apertures 116 having diameters D3 coincident with the first axis A1. As also shown in FIG. 4, the second end portion 107 of the first mating surface 102 is disposed offset 113 from the first mating surface 102. Preferably, the offset 113 is at least approximately the thickness of the material used to construct the patterned frame rail 100. In one embodiment, the offset 113 is approximately 0.063 inches.

In an embodiment, the first end portion 105 of the first mating surface 102 is disposed offset 113 from the first mating surface 102.

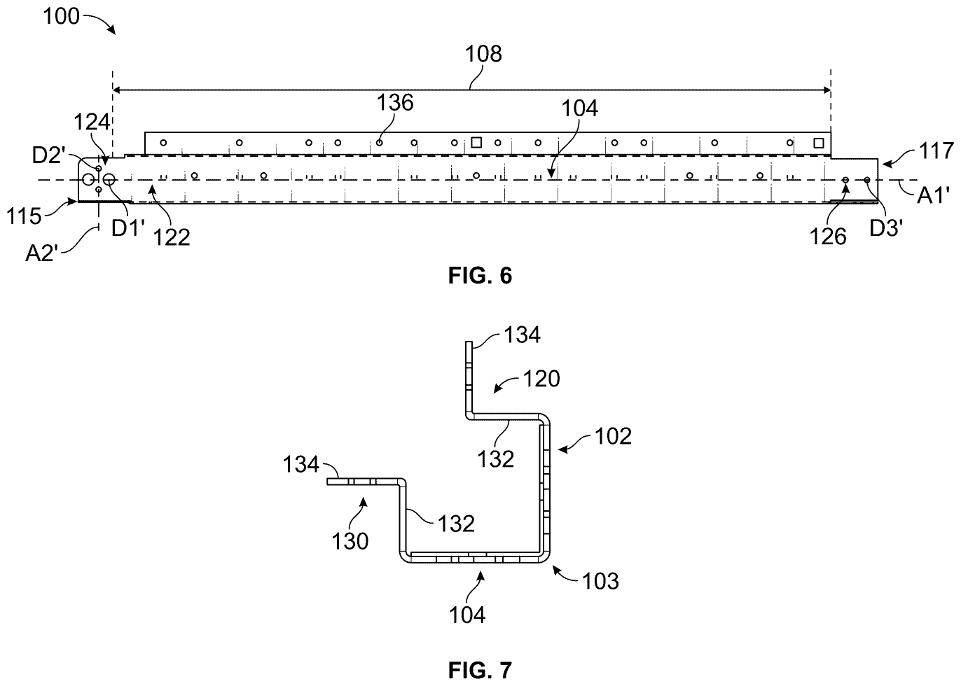

FIG. 6 is a second elevation view of the patterned frame rail 100 of FIG. 1. The second mating surface 104 may include a first end portion 115 and a second end portion 117. Preferably, each of the first and second end portions 115, 117 are disposed outside the intermediate portion 108 on opposite ends of the second mating surface 104. The first and second end portions 115, 117 of the second mating surface are formed and defined substantially identical to the first and second end portions 105, 107 of the first mating surface 102, but disposed such that the first end portion 105 of the first mating surface 102 is disposed adjacent the second end portion 117 of the second mating surface 104 with the gap 106 disposed therebetween, and the second end portion 107 of the first mating surface 102 is disposed adjacent the first end portion 115 of the second mating surface 104 with the gap 106 disposed therebetween.

The first end portion 115 of the second mating surface 104 may include a first pair of apertures 122 that may have a first diameter D1′ and the second pair of apertures 124 that may have a second diameter D2′. Preferably, the first diameter D1′ is larger than the second diameter D2′. The first diameters D1′ of the first pair of apertures 122 may be coincident with a first axis A1′ and the second diameters D2′ of the second pair of apertures 124 may be coincident with a second axis A2′. Preferably, the first axis A1′ and second axis A2′ are disposed normal to one another.

The second end portion 117 of the second mating surface 104 may include a pair of apertures 126 having diameters D3′ coincident with the first axis A1′. As also shown in FIG. 4, the second end portion 117 of the second mating surface 104 is disposed offset 113 from the second mating surface 104. Preferably, the offset 113 is at least approximately the thickness of the material used to construct the patterned frame rail 100. In one embodiment, the offset 113 is approximately 0.063 inches.

In an embodiment, the first end portion 105 of the first mating surface 102 is disposed offset 113 from the first mating surface 102.

The outer frame rails 120, 130 are substantially identical, so for the sake of brevity only one outer frame rail will be described in detail. An outer frame rail 120, 130 extends from an outer longitudinal edge of the intermediate portion 108 of one of the respective opposed first and second mating surfaces 102, 104 of the inner frame rail 110 to define an offset portion 132 oriented normal to the respective mating surface 102, 104 and a mounting flange 134 oriented normal to the offset portion 132. FIG. 7 more clearly illustrates the outer frame rail 120, 130 arrangement. A series of apertures 136 are defined in the mounting flange 134 in order to facilitate connection of other structures and components thereto in any suitable manner. For example, when the patterned frame rail 100 is used to construct a modular HVAC component unit, the functionally operational components may be secured to the apertures 136, as desired.

A series of apertures 138 are defined in the first and second mating surfaces 102, 104 in order to facilitate connection of other structures and components thereto in any suitable manner. For example, when a plurality of patterned frame rails 100 are used to construct a modular HVAC component unit, such as the cube shown in FIG. 10, the adjacent cubes may be secured to one another by the apertures 138, as desired. Additionally, side panels (not shown) could also be connected to the patterned frame rails 100 by the apertures 138, as desired.

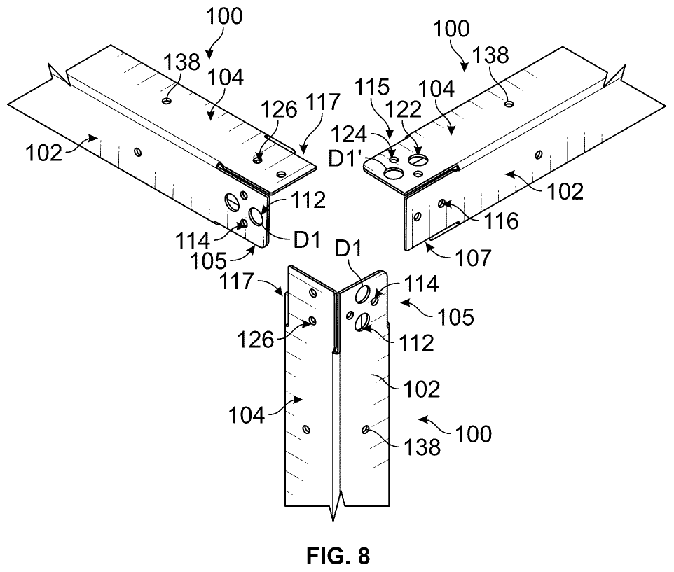

FIG. 8 is a perspective view of a set of three of the patterned frame rails 100 of FIG. 1 oriented to be connected to define a corner. The first end portions 105, 105, 115 are disposed to be moved into alignment over the respective second end portions 117, 107, 117 that are disposed offset 113 from the respective second mating surface 104, first mating surface 102, and second mating surface 104. The respective second pair of apertures 114, 114, 124 disposed on the respective first end portions 105, 105, 115 are oriented to be moved into alignment over and in registration with the pair of apertures 126, 116, 126 so that a fastener may be inserted therethrough to connect the patterned frame rails 100 to one another. The fastener may be an suitable structural device, temporary or permanent, that facilitates a clamping force along the longitudinal axis or axial orientation of the fastener. For example, the fastener may be a rivet, bolt and nut, or other suitable device to achieve the intended functionality.

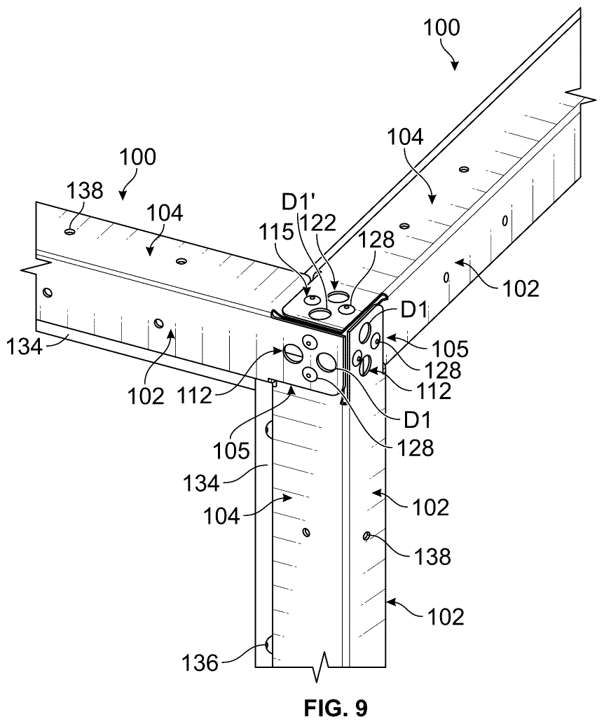

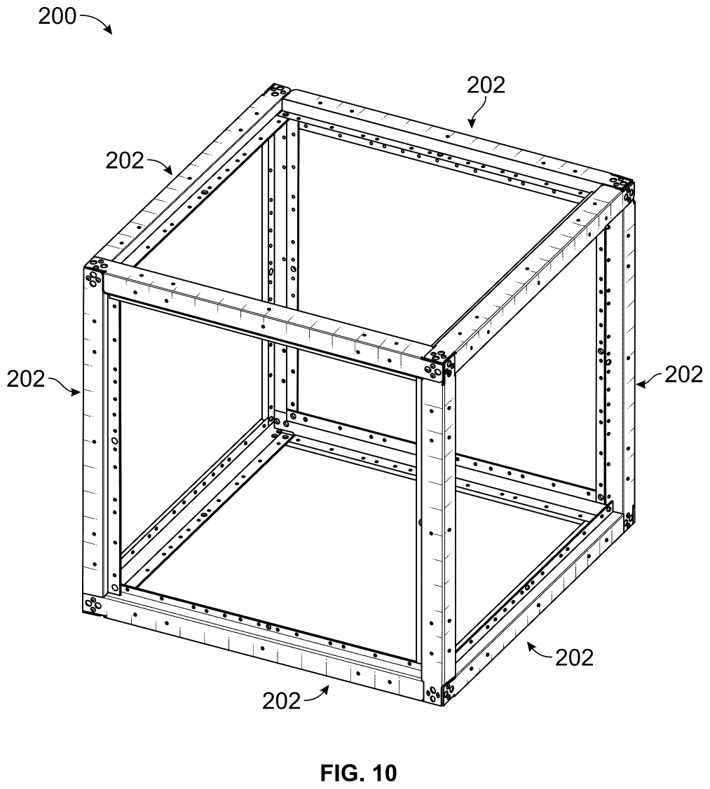

FIG. 9 is a perspective view of the three patterned frame rails 100 of FIG. 8 connected by a plurality of fasteners 128 to define a corner. The offset 113 facilitates disposition of the first end portions 105, 105, 115 in alignment over the respective second end portions 117, 107, 117 such that the first end portions 105, 105, 115 remain coplanar with the respective first mating surfaces 102, 102 and second mating surface 104. The respective first pair of apertures 112, 112, 122 each have a respective diameter D1, D1, and D1′ that is greater than the diameter of the fastener 128 so that another apparatus constructed of a plurality of patterned frame rails 100 when disposed immediately adjacent the fasteners 128 that stand proud of the respective first mating surfaces 102, 102, and second mating surfaces 104 will be received into the first pair of apertures on the another apparatus. Such an arrangement facilitates a flush fitment of the respective mating surfaces so that a seal is substantially formed about and along the mating surface engagement. For example, FIG. 10 is a perspective view of a set of twelve of the patterned frame rails 100 of FIG. 1 connected, as described herein to define a cube 200 and a plurality of distinct panels 202 (i.e., four frame rails 100 connected as described herein define a panel 202) therein.

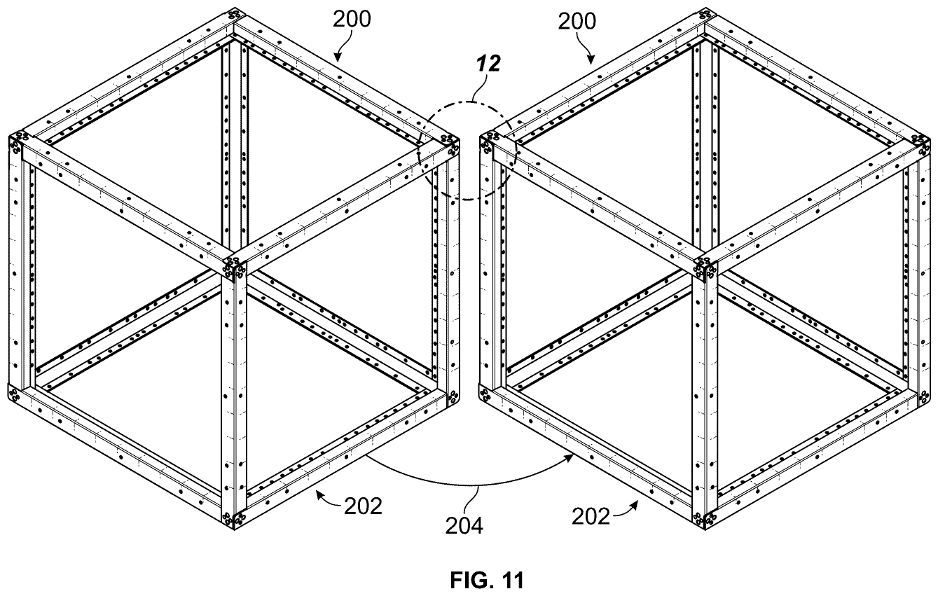

FIG. 11 is a perspective view of a pair of cubes 200 of FIG. 10 constructed in accordance with the teachings herein. The cubes 200 are oriented to be moved into immediately adjacent disposition by movement of one cube 200 (i.e., the cube 200 on the left side of FIG. 11) in the direction 204. The cubes 200 are disposed immediately adjacent to one another when the respective mating surfaces 102, 104 of one panel 202 on each of the respective cubes 200 are in contact with respective mating surfaces 102, 104 of another panel so as to be disposed in a flush fitment so that a seal is substantially formed along the mating surfaces 102, 104 engagement about the perimeter of the panels 202.

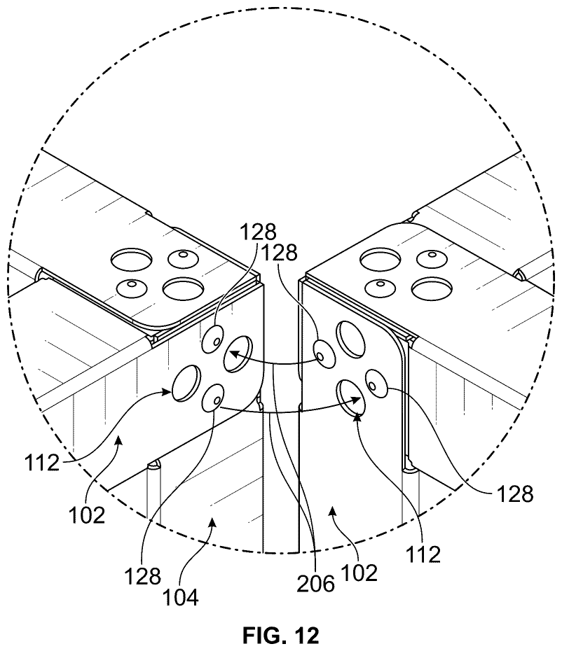

FIG. 12 is a detailed perspective view from FIG. 11 of one corner of each of the pair of cubes 200 of FIG. 11. The fasteners 128 that stand proud on one panel 202 will be moved in direction 206 when the cube 200 is moved in direction 204 so as to be received in the first pair of apertures 112 on the other panel and vice versa. As a result, the respective mating surfaces 102, 104 of the panels 202 are disposed in a flush fitment so that a seal is substantially formed along the mating surfaces 102, 104 engagement about the perimeter of the panels 202. The cubes 200 may then be permanently or temporarily connected to one another with fasteners 128 through the apertures 138, as desired.

In an embodiment, a sheet of material may be oriented within the panel 202 such that the sheet of material may is disposed between the offset portions 132 of the frame rails 100 and the mounting flange 134 provides a backstop for the sheet of material. In an embodiment, the sheet of material is secured in place by fastening the sheet of material to the mounting flange 134 via the plurality of apertures 136.

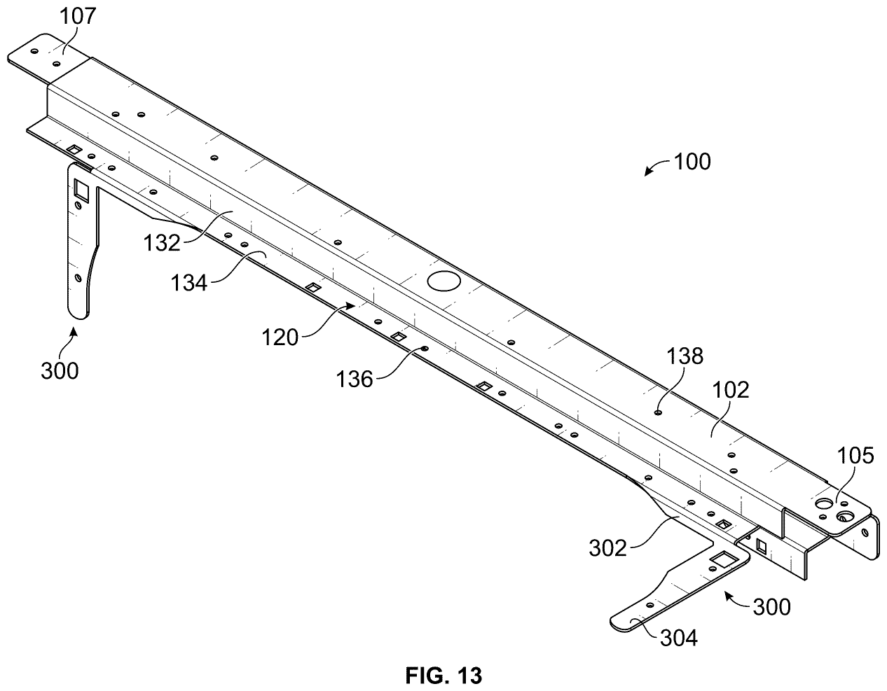

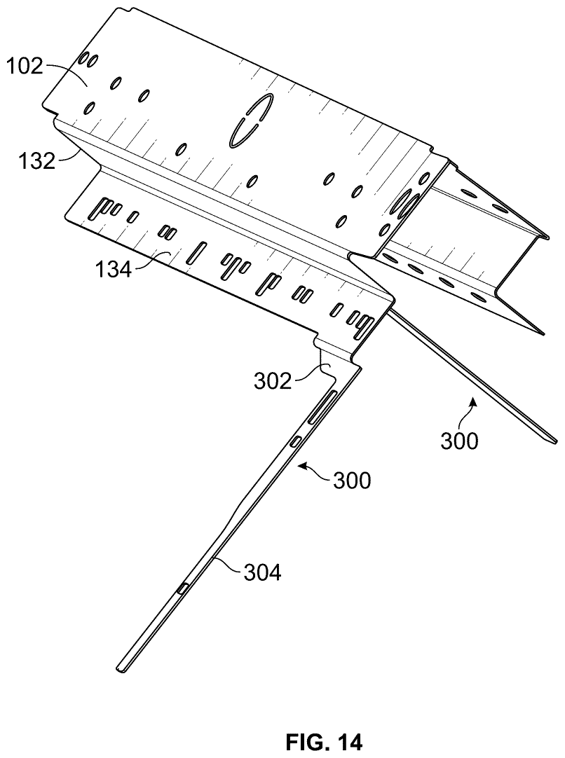

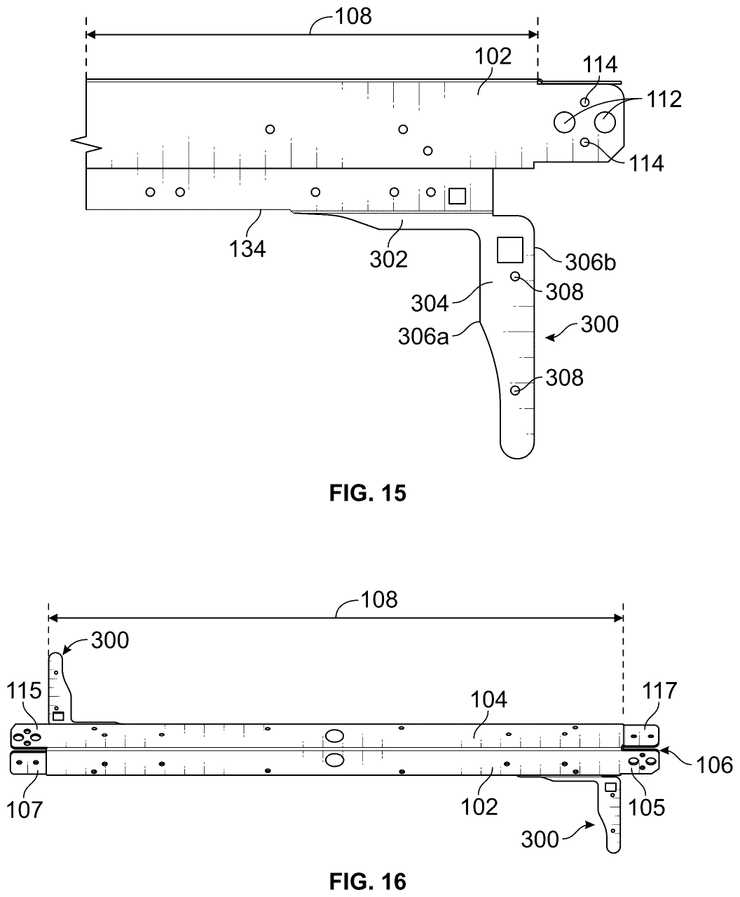

FIGS. 13-16 depict an embodiment of the patterned frame rail 100 having a gusset 300. The gusset 300 may be configured as an L-shaped bracket having a first portion 302 that forms the base of the “L” that is in parallel with and extending along a portion of the length of the mounting flange 134 adjacent the first ends 105, 115 of the frame rail 100 and a second portion 304 that form the upright of the “L” that extends away from the mounting flange 134 and forming a right angle with the first portion 302. The gusset 300 further comprises a plurality of apertures to facilitate connection of other structures and components thereto in any suitable manner. The gusset 300 provides additional support and stability of for each panel 202 when the frame rails 100 are oriented to form a cube 200.

In an embodiment, the gusset 300 is connected to the mounting flange 134 by an offset portion that extends normal to the mounting flange 134.

The first portion 302 of the gusset 300 extends from an outer longitudinal edge of the mounting flange 134 proximate the first ends 105, 115 of the first and second mating surfaces 102, 104. In a preferred embodiment, the second portion 304 comprises an inner edge 306a and an outer edge 306b, wherein the outer edge 306b is oriented in parallel edge alignment with the edge of the intermediate portion 108 (i.e., the area of the intermediate portion 108 that abuts the first ends 105, 107). In an embodiment, the outer edge 306b and edge of the intermediate portion 108 are aligned along the same sectional plane.

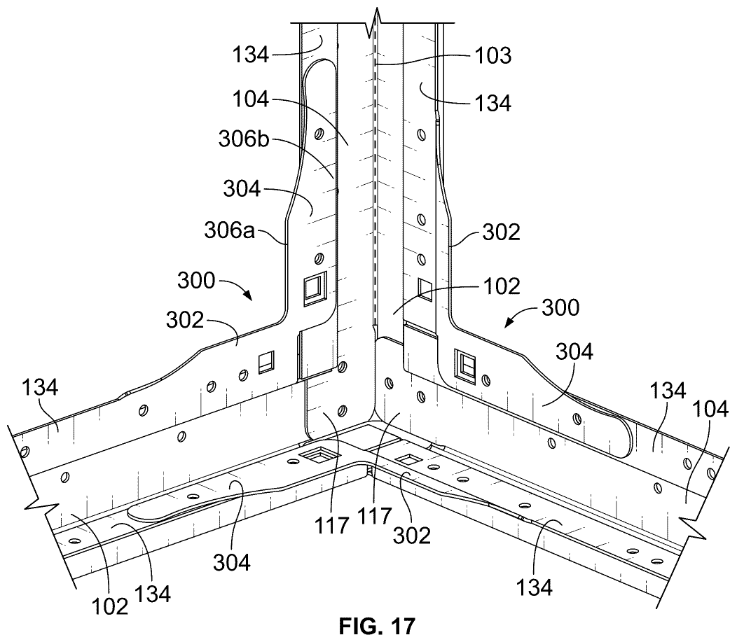

FIG. 17 is a perspective view of a set of three of the patterned frame rails 100 of FIGS. 13-16 connected to define a corner. FIG. 17 depicts the corner from the perspective of the inside of a cube 200. First end portions 105, 115 (hidden from view) are disposed to be moved into alignment over the respective send end portions 107, 117 that are disposed offset 113 from the respective second mating surfaces 104 and first mating surfaces 102. The respective second pair of apertures 114, 124 disposed on the respective first end portions 105, 115 are oriented to be moved into alignment over and in registration with the pair of apertures 116, 126 so that a fastener may be inserted therethrough to connect the patterned frame rails 100 to one another. The fastener may be an suitable structural device, temporary or permanent, that facilitates a clamping force along the longitudinal axis or axial orientation of the fastener. For example, the fastener may be a rivet, bolt and nut, or other suitable device to achieve the intended functionality.

FIG. 17 shows the mounting flanges 134 of the first and second mating surfaces 102, 104 from the perspective of the interior of the cube 200. Then the patterned frame rails 100 having gussets 300 are connected to define a corner, the first portions of the gussets 302 extend from the mounting flanges 134 of the first mating surfaces 102. Between the first portions of the gussets 302 and the mounting flanges of the first mating surfaces 102 are offset portions that extend normal to the mounting flanges 134 and away from the mating surfaces 102. Due to the offset portions, the gussets 300 are closer to the interior of the cube 200 than the other components of the patterned frame rails 100 when the patterned frame rails 100 are connected to form a corner.

The second portions of the gussets 304 are disposed to be moved into alignment under the respective mounting flanges 134 of the second mating surfaces 104 (such that the second portions of the gussets 304 are closer to the interior of the cube 200 than the mounting flanges 134). A plurality of apertures 308 are disposed along the second portions of the gussets 304 are oriented to be moved into alignment over and in registration with apertures 136 disposed along the mounting flanges 134 so that a fastener may be inserted therethrough to fasten the gussets 304 to the mounting flanges 134.

In an embodiment, the cube 200 may be developed from a combination of frame rails 100 which include and do not include the gusset 300. In other embodiments, the cube 200 may be developed entirely from frame rails 100 which do (or do not) include the gusset 300.

Although the present invention and its advantages have been described in detail, it should be understood that various changes, substitutions and alterations can be made herein without departing from the spirit and scope of the invention as defined in the appended claims. Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A frame rail comprising:
a first mating surface and a second mating surface joined at a vertex, the first and second mating surfaces each having a first end, a second end, and an intermediate portion disposed therebetween;
a first offset portion oriented normal to the first mating surface and a second offset portion oriented normal to the second mating surface; and
a first mounting flange oriented normal to the first offset portion and a second mounting flange oriented normal to the second offset portion.

2. The frame rail of claim 1, wherein:
the first end of the first mating surface is adjacent to the second end of the second mating surface,
the second end of the first mating surface is adjacent to the first end of the second mating surface, and
a gap separates the first end of the first mating surface from the second end of the second mating surface and the second end of the first mating surface from the first end of the second mating surface.

3. The frame rail of claim 2 wherein the first ends of the first mating surface and second mating surface further comprise:
a first pair of apertures having a diameter of x and oriented along a first axis, and
a second pair of apertures having a diameter of y and oriented along a second axis.

4. The frame rail of claim 3, wherein:
the second end of the first mating surface is offset from the vertex and the edge of the first mating surface opposite the vertex;
the second end of the second mating surface is offset from the vertex and the edge of the second mating surface opposite the vertex; and
the second ends of the first mating surface and second mating surface further comprise a third pair of apertures having a diameter of x and oriented along the second axis.

5. The frame rail of claim 4, wherein the first axis is perpendicular to the vertex and the second axis is parallel to the vertex.

6. The frame rail of claim 5, wherein diameter x is less than diameter y.

7. The frame rail of claim 6, further comprising a first gusset extending from the first mounting flange and a second gusset extending from the second mounting flange.

8. The frame rail of claim 7, wherein the first gusset forms an L-shaped bracket and comprises:
a first portion in parallel with and extending along a portion of the length of the first mounting flange, and
a second portion extending away from the first mounting flange and forming a right angle with the first portion.

9. The frame rail of claim 8, wherein the second gusset forms an L-shaped bracket and comprises:
a first portion in parallel with and extending along a portion of the length of the second mounting flange; and
a second portion extending away from the second mounting flange and forming a right angle with the first portion.

10. The frame rail of claim 9, wherein the first gusset is connected to the first mounting flange by an offset portion that extends normal to the first mounting flange.

11. The frame rail of claim 9, wherein the first portion of the first gusset extends from an outer longitudinal edge of the first mounting flange proximate the first end of the first mating surface.

12. The frame rail of claim 11, wherein the first portion of the second gusset extends from an outer longitudinal edge of the second mounting flange proximate the first end of the second mating surface.

13. The frame rail of claim 12, wherein each of the first and second gussets further comprise an outer edge disposed at one end of the second portion, the outer edge oriented in parallel and planar alignment with an edge of the intermediate portion.

14. A method of assembling a corner of a frame comprising:
obtaining a plurality of frame rails, each of the frame rails comprising:
a first mating surface and a second mating surface joined at a vertex, the first and second mating surfaces each having a first end, a second end, and an intermediate portion disposed therebetween;
a first offset portion oriented normal to the first mating surface and a second offset portion oriented normal to the second mating surface;
a first mounting flange oriented normal to the first offset portion and a second mounting flange oriented normal to the second offset portion;
the first ends of the first mating surface and second mating surface further comprise a first pair of apertures having a diameter of x and oriented along a first axis, and a second pair of apertures having a diameter of y and oriented along a second axis; and
the second ends of the first mating surface and second mating surface further comprise a third pair of apertures having a diameter of x and oriented along the second axis;
orienting the first end of a first mounting flange of a first frame rail over a second end of a first mounting flange of a second frame rail such that the first pair of apertures are aligned in registration with the third pair of apertures;
orienting the first end of a second mounting flange of the second frame rail over a second end of a first mounting flange of a third frame rail such that the first pair of apertures are aligned in registration with the third pair of apertures;
orienting the first end of a second mounting flange of the third frame rail over a second end of a first mounting flange of the first frame rail such that the first pair of apertures are aligned in registration with the third pair of apertures; and
forming a corner of a frame by securing the first, second, and third frame rails by applying fasteners to the first and third pairs of apertures which are aligned in registration.

15. A cubic frame comprising:
a set of 12 frame rails, each of the frame rails comprising:
a first mating surface and a second mating surface joined at a vertex, the first and second mating surfaces each having a first end, a second end, and an intermediate portion disposed therebetween;
a first offset portion oriented normal to the first mating surface and a second offset portion oriented normal to the second mating surface;
a first mounting flange oriented normal to the first offset portion and a second mounting flange oriented normal to the second offset portion;
the first end of the first mating surface is adjacent to the second end of the second mating surface;
the second end of the first mating surface is adjacent to the first end of the second mating surface;
a gap separates the first end of the first mating surface from the second end of the second mating surface and the second end of the first mating surface from the first end of the second mating surface;
wherein the first ends of the first mating surface and second mating surface further comprise:
a first pair of apertures having a diameter of x and oriented along a first axis; and
a second pair of apertures having a diameter of y and oriented along a second axis;
wherein the second ends of the first mating surface and second mating surface further comprise a third pair of apertures having a diameter of x and oriented along the second axis;
a set of 48 fasteners to secure the first end of the first mating surface of each frame rail to the second end of the second mating surface of another frame rail;
wherein, at each corner of the cubic frame:
the first end of the first mounting flange of a first frame rail is disposed over the second end of the first mounting flange of a second frame rail such that the first pair of apertures are aligned in registration with the third pair of apertures;
the first end of the first mounting flange of the second frame rail is disposed over a the second end of the first mounting flange of a third frame rail such that the first pair of apertures are aligned in registration with the third pair of apertures;
the first end of the second mounting flange of the third frame rail is disposed over the second end of the second mounting flange of the first frame rail such that the first pair of apertures are aligned in registration with the third pair of apertures.
